(19) United States
(12) Patent Application Publication
(10) Pub. No.: US 2012/0033050 A1
(43) Pub. Date: Feb. 9, 2012

(54) IMAGING APPARATUS

(76) Inventor: Hiroshi KOMURO, Osaka (JP)

(21) Appl. No.: 13/198,211

(22) Filed: Aug. 4, 2011

(30) Foreign Application Priority Data
Aug. 5, 2010 (JP) 2010-175961

(51) Int. Cl. H04N 13/02

(52) U.S. Cl. 348/49; 348/E13.074

(57) ABSTRACT

An imaging apparatus includes an imaging device configure to generate image data from a subject image, a connecting unit configured to connect a 3D conversion lens for enabling a left-eye image and a right-eye image to be simultaneously formed on the imaging device, a measuring unit configured to obtain brightness of an image formed on the imaging device and generate measuring information representing the brightness of the image formed on the imaging device based on the obtained brightness of the image, an exposure adjusting unit configured to control exposure on the imaging device based on the measuring information, and a light amount correcting unit configured to reduce an influence of light falloff occurring in the image formed on the imaging device to the measuring information, when the 3D conversion lens is connected to the connecting unit.

### BACKGROUND OF THE INVENTION

1. Technical Field

The present invention relates to an imaging apparatus, and more particularly to an imaging apparatus to which a 3D conversion lens for enabling a stereoscopic image to be shot with a single lens imaging apparatus can be attached.

2. Related Art

JP2001-222083A discloses an imaging apparatus to which a stereo adapter for enabling a stereoscopic image to be shot with a single lens camera can be connected. This imaging apparatus can capture a left-eye image and a right-eye image as a side-by-side image with the stereo adapter attached to the imaging apparatus. The imaging apparatus carries out exposure metering based on brightness of either one of a left-eye image and a right-eye image in exposure control. With this method, the imaging apparatus realizes the exposure metering of a side-by-side image.

The inventors of this application found the phenomenon in that when a device such as a stereo adapter for enabling shooting of a stereoscopic image is attached to a single lens imaging apparatus, light falloff occurs locally on an image captured by an imaging device or the imaging apparatus.

The light falloff which is caused by the attachment of such a stereo adapter and is different from a normal light falloff influences accuracy of the exposure metering in the exposure control so that suitable exposure metering is prohibited.

### SUMMARY OF THE INVENTION

The present invention has been devised in order to solve the above problem, and has an object to provide an imaging apparatus that can carry out accurate exposure metering in the exposure control even when the stereo adaptor (a 3D conversion lens) is attached.

An imaging apparatus according to the present invention includes an imaging device configure to generate image data from a subject image, a connecting unit configured to connect a 3D conversion lens for enabling a left-eye image and a right-eye image to be simultaneously formed on the imaging device, a measuring unit configured to obtain brightness of an image formed on the imaging device and generate measuring information representing the brightness of the image formed on the imaging device based on the obtained brightness of the image, an exposure adjusting unit configured to control exposure on the imaging device based on the measuring information, and a light amount correcting unit configured to reduce an influence of light falloff occurring in the image formed on the imaging device to the measuring information, when the 3D conversion lens is connected to the connecting unit.

According to the present invention, when a 3D conversion lens is attached to the imaging apparatus, an influence of light falloff in the exposure metering information, which occurs on an image and is caused by the 3D conversion lens, is reduced. As a result, the influence of the light falloff caused by the 3D conversion lens can be eliminated, so that the exposure metering can be carried out accurately.

### BRIEF DESCRIPTION OF DRAWINGS

FIG. 1 is a perspective view illustrating a digital video camera to which a 3D conversion lens is attached.

FIG. 2 is a diagram describing an example of an image formed on a CCD image sensor of the digital video camera to which the 3D conversion lens is attached.

FIG. 3 is a block diagram illustrating a configuration of the digital video camera.

FIG. 4 is a diagram describing optical systems of the 3D conversion lens and the digital video camera.

FIG. 5 is a diagram describing an image of a side-by-side format generated by the digital video camera to which the 3D conversion lens is attached.

FIGS. 6A and 6B are diagrams for describing light falloff at a center caused by the 3D conversion lens.

FIG. 7 is a flowchart for describing exposure metering and exposure control operations of the digital video camera.

FIGS. 8A and 8B are diagrams for describing center-weighted exposure metering for shooting a 2D image.

FIGS. 9A and 9B are diagrams for describing the center-weighted exposure metering for shooting a 3D image.

FIG. 10 is a diagram describing a correction coefficient to be used for correcting a light amount.

### DETAILED DESCRIPTION OF PREFERRED EMBODIMENTS

Embodiments according to the present invention will be described below with reference to the accompanying drawings.

### 1. First Embodiment

### 1-1. Overview

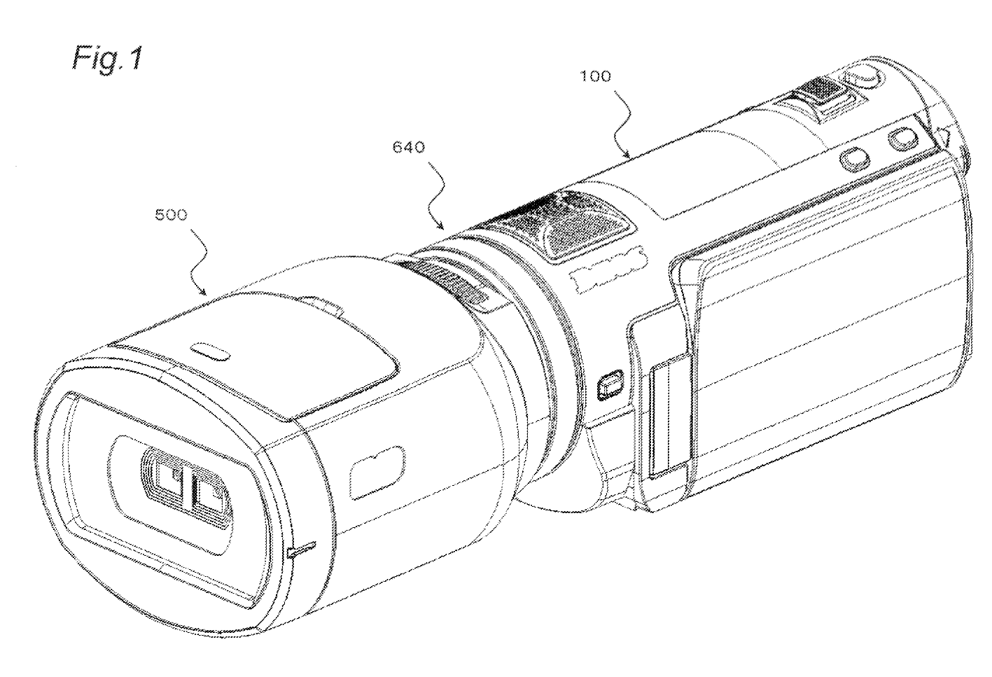

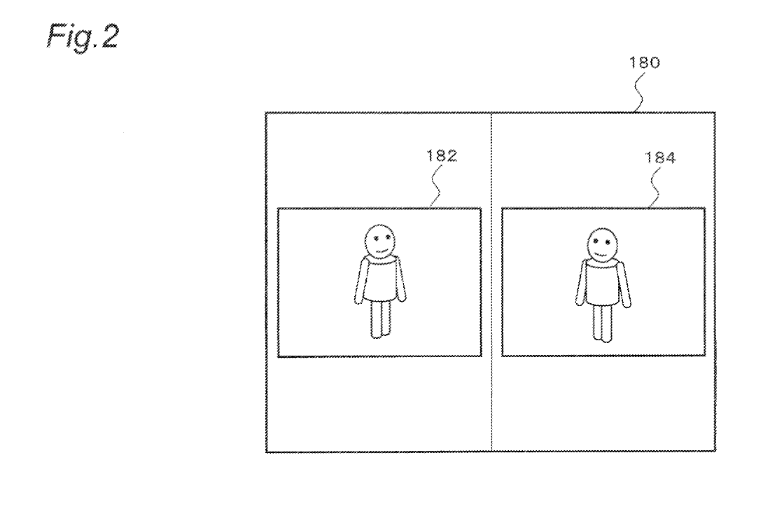

An outline of a digital video camera according to a first embodiment of the present invention will be described with reference to FIGS. 1 and 2. FIG. 1 is a perspective view illustrating a state that a 3D conversion lens 500 is attached to a digital video camera 100.

The 3D conversion lens 500 can be attached to the digital video camera 100 via a connecting section 640. The digital video camera 100 can magnetically detect attachment/detachment of the 3D conversion lens 500 with a detection switch.

The 3D conversion lens 500 has a right-eye lens for guiding light for forming a right-eye image in a 3D (three dimensions) image to an optical system of the digital video camera 100, and a left-eye lens for guiding light for forming a left-eye image to the optical system.

The light incident via the 3D conversion lens 500 is imaged as a 3D image of a side-by-side format as shown in FIG. 2 on a CCD image sensor of the digital video camera 100. Particularly, the 3D conversion lens 500 has an optical property such that light falls off near a boundary between a left-eye image 182 and a right-eye image 134 (hereinafter referred to as “light falloff at a center”). A configuration of the digital video camera enabling suitable exposure metering without being influenced by such an optical property of the 3D conversion lens 500 (the light falloff at a center) will be described below.

### 1-2. Configuration

### 1-2-1. Configuration of Digital Video Camera

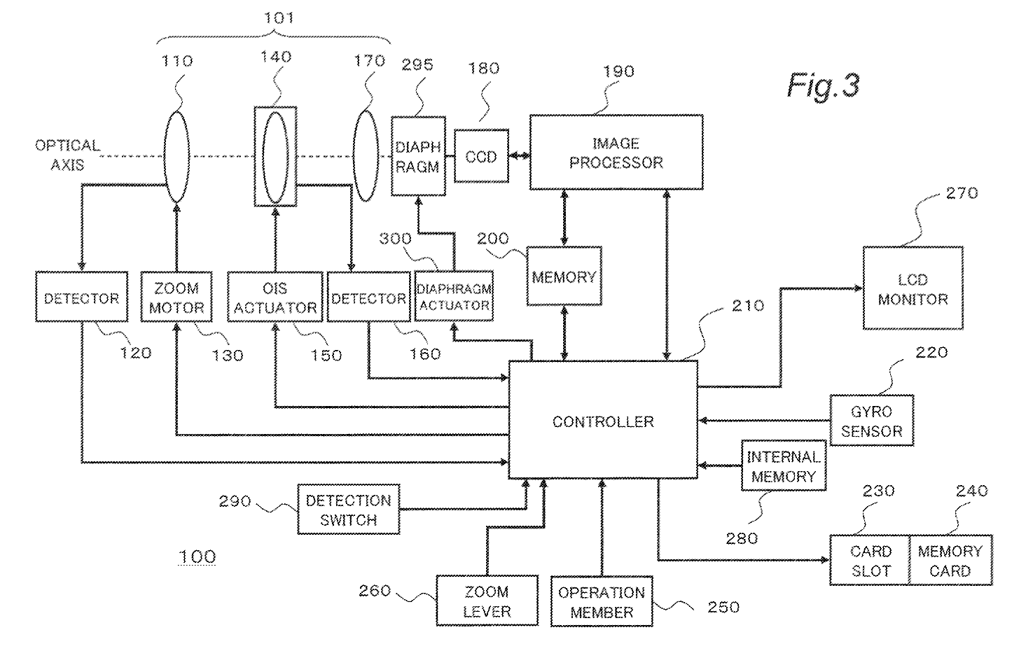

An electrical configuration of the digital video camera 100 according to the first embodiment will be described with reference to FIG. 3. FIG. 3 is a block diagram, illustrating a configuration of the digital video camera 100. The digital video camera 100 has an optical system 101, a CCD image sensor 180, an image processor 190, a liquid crystal display (LCD) monitor 270, a detector 120, a zoom motor 130, an OIS actuator 150, a detector 160, a memory 200, a controller 210, a zoom lever 260, an operation member 250, an internal memory 280, a gyro sensor 220, a card slot 230, and a detection switch 290. The digital video camera 100 captures a subject image formed by the optical system 101 with the CCD image sensor 180. Video data generated by the CCD image sensor 180 is subject to various processes in the image processor 190, and is stored in a memory card 240. Further, the video data stored in the memory card 240 can be displayed on the LCD monitor 270. The configuration of the digital video camera 100 will be described in detail below.

The optical system 101 of the digital video camera 100 includes a zoom lens 110, an OIS 140, and a focus lens 170. The zoom lens 110 moves along an optical axis of the optical system 101 to enlarge or reduce a subject image. The focus lens 170 moves along the optical axis of the optical system 101 to adjust a focus of the subject image.

The OIS 140 has inside a correction lens that can move on a plane vertical to the optical axis. The OIS 140 drives the correction lens to a direction in which a shake of the digital video camera 100 is cancelled so as to reduce blur of a subject image.

The zoom motor 130 drives the zoom lens 110. The zoom motor 130 may be realized by a pulse motor, a DC motor, a linear motor, or a servo motor. The zoom motor 130 may drive the zoom lens 110 via a cam mechanism or a mechanism such as a ball screw. The detector 120 detects a position on the optical axis where the zoom lens 110 is present. The detector 120 outputs a signal relating to a position of the zoom lens using a switch such as a brush according to the motion of the zoom lens 110 to a direction of the optical axis.

The OIS actuator 150 drives the correction lens in the OIS 140 on a plane vertical to the optical axis. The OIS actuator 150 can be realized by a planar coil, an ultrasonic motor, or the like. Further, the detector 160 detects a amount of move of the correction lens in the OIS 140.

A diaphragm 295 adjusts an amount of light incident on the CCD image sensor 180. Narrowing the diaphragm 295 allows the amount of the light incident on the CCD image sensor 180 to be reduced. Opening the diaphragm 295 allows the amount of the light incident on the CCD image sensor 180 to be increased. A diaphragm actuator 300 is an actuator for driving the diaphragm 295.

The CCD image sensor 180 captures a subject image formed on the optical system 101 to generate video data. The CCD image sensor 180 performs various operations such as exposure, transfer and electronic shutter.

The image processor 190 executes various processes on the video data generated by the CCD image sensor 180. The image processor 190 generates video data to be displayed on the LCD monitor 270, and generates video data to be restored in the memory card 240. For example, the image processor 190 executes various processes, such as gamma correction, white balance correction, and scrape correction on the video data generated by the CCD image sensor 180. The image processor 190 compresses the video data generated by the CCD image sensor 180 according to a compressing format con forming to H.264 standards and MEG2 standards. The image processor 190 can be realized by DSP or a microcomputer.

The controller 210 is a control unit for controlling the entire operation of the digital video camera. The controller 210 can be realized by a semiconductor element or the like. The controller 210 may be realized by only hardware or by combination of hardware and software. The controller 210 can be realized by a microcomputer or the like.

The memory 200 functions as a work memory for the image processor 190 and the controller 210. The memory 200 can be realized by, for example, a DRAM or a ferroelectric memory.

The LCD monitor 270 can display an image represented by the video data generated by the CCD image sensor 180 and an image represented by the video data read from the memory card 240.

The gyro sensor 220 includes a vibration material such as a piezoelectric element. The gyro sensor 220 converts a force caused by a Coriolis force occurring on vibrating the vibration material such as the piezoelectric element at a constant frequency into a voltage to acquire angular velocity information. The digital video camera 100 acquires the angular velocity information from the gyro sensor 220, and drives the correction lens in the CTS 140 in a direction for canceling the vibration, so as to correct a camera shake caused by a user.

The memory card 240 can be attached to/detached from the card slot 230. The card slot 230 can be mechanically and electrically connected to the memory card 240. The memory card 240 includes a flash memory and a ferroelectric memory and can store data.

The internal memory 280 includes a flash memory or a ferroelectric memory. The internal memory 280 stores a control program or the like for entirely controlling the digital video camera 100.

The operation member 250 is a member that receives an operation from the user. The zoom lever 260 is a member that receives an instruction for changing zoom magnification from the user.

The detection switch 290 can magnetically detect attachment (connection) of the 3D conversion lens 500 to the digital video camera 100. When detecting the attachment of the 3D conversion lens 500, the detection switch 290 sends a signal representing the attachment to the controller 210. In this manner, the controller 210 can detect that the 3D conversion lens 500 is attached to or detached from the digital video camera 100.

### 1-2-2. Configuration of 3D Conversion Lens

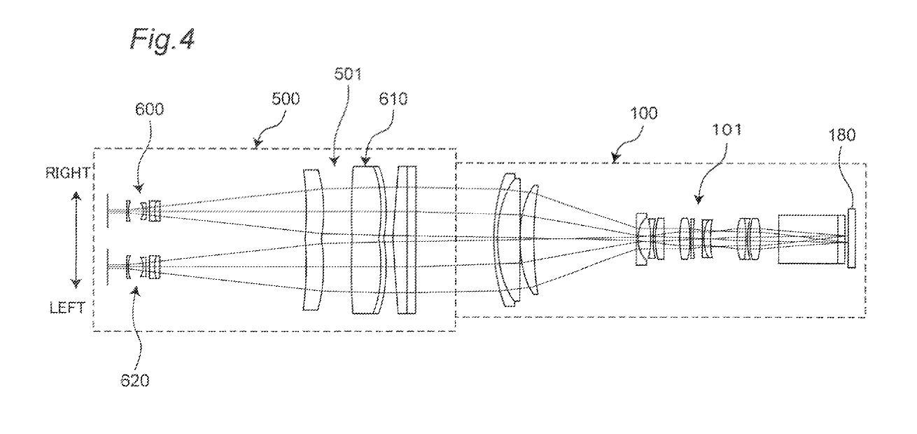

FIG. 4 is a diagram describing configurations of an optical system 501 of the 3D conversion lens 500 and the optical system 101 of the digital video camera 100. The optical system 501 of the 3D conversion lens 500 has a right-eye lens 600 for guiding light for forming a right-eye image on a 3D image, a left-eye lens 620 for guiding light for forming a left-eye image, and a common lens 610, which is made integrally by a right eye lens and a left eye lens, for guiding the light incident through the right-eye lens 600 and the light incident through the left-eye lens 620 to an optical system 101 of the digital video camera 100. The light incident to the right-eye lens 600 and the left-eye lens 620 of the 3D conversion lens 500 is guided to the optical system 101 of the digital video camera 100 via the common lens 610 to image an image of a side-by-side format as shown in FIG. 2, for example, on the CCD image sensor 180 of the digital video camera 100, so that image data is generated by the CCD image sensor 180.

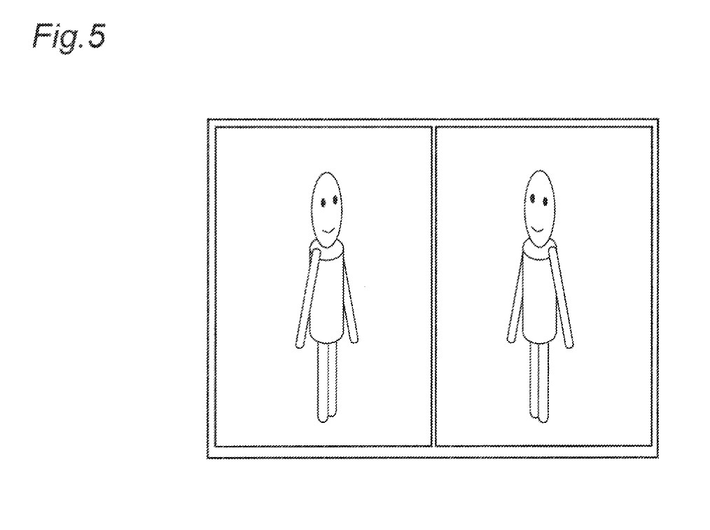

The image data generated by the CCD image sensor 180 is expanded in a vertical direction by the image processor 190, and finally image data of a side-by-side format as shown in FIG. 5 is generated.

### 1-3. Light Falloff at Center

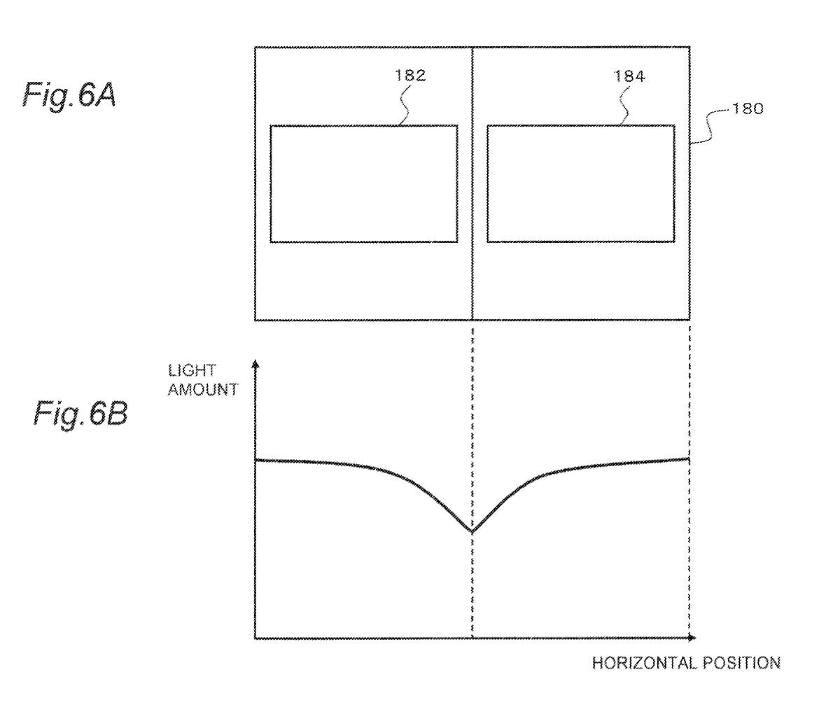

The light falloff caused by the 3D conversion lens 500 will be described. As shown in FIG. 6A, when the 3D conversion lens 500 is attached to the digital video camera 100, an image for a left eye is formed on a region 182 of the CCD image sensor 180, and an image for a right-eye is formed on a region 184. FIG. 6B is a diagram describing a change in an amount of light incident or the CCD image sensor 180 with respect to a horizontal position of the CCD image sensor 180 with the 3D conversion lens 500 attached to the digital video camera 100. As shown in FIG. 63, the light fallout (light falloff at a center) occurs near a center of the CCD image sensor 180 in the horizontal direction. The light falloff at the center is considered to be caused by, as shown in FIG. 4, the two optical systems included in the 3D conversion lens 500, including the right-eye lens 600 and the left-eye lens 620. The digital video camera 100 according to the first embodiment has a function for reducing an influence or the light falloff at the center as shown in FIG. 6B at the time of exposure metering (The details will be described later.).

### 1-4. Exposure Metering and Exposure Control Operations

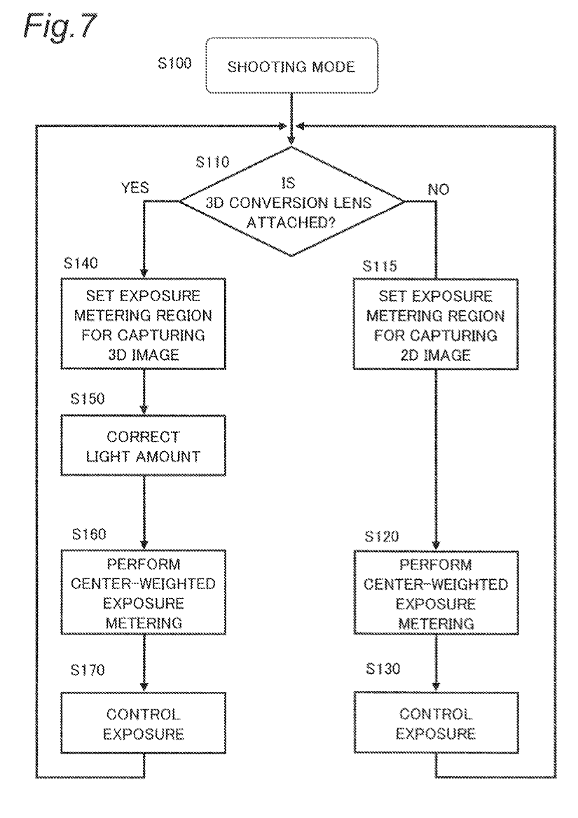

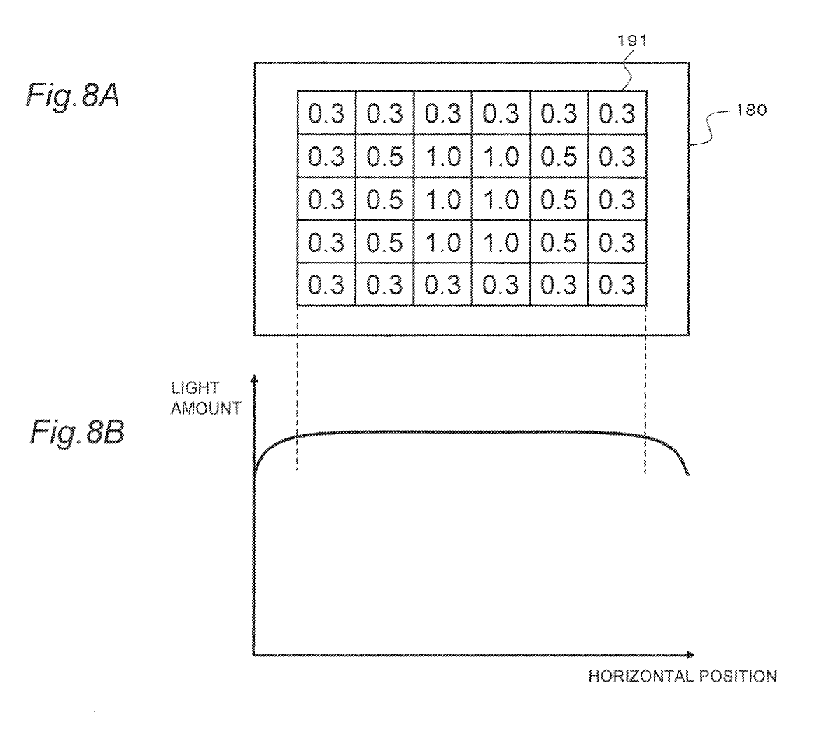

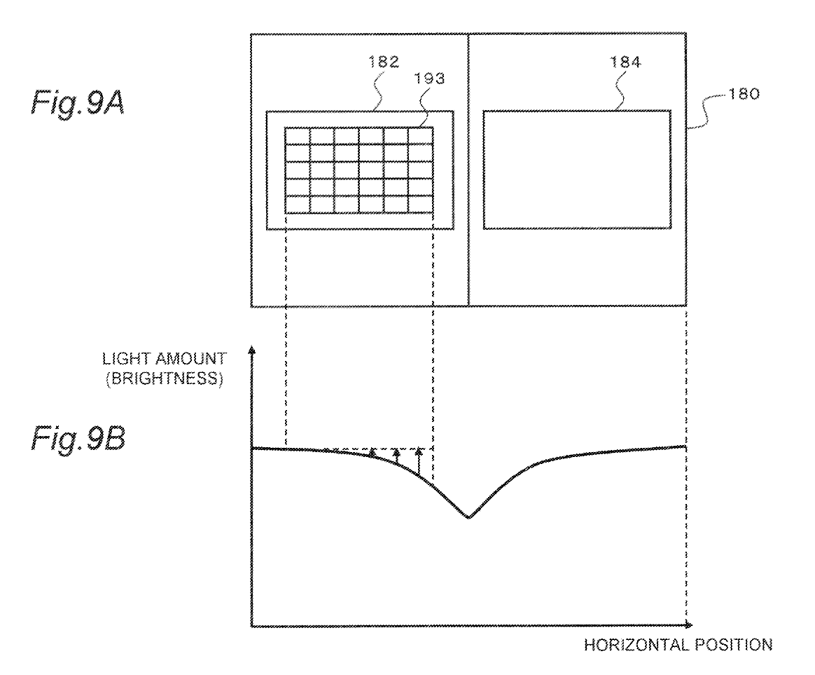

The exposure metering and exposure control operations in the digital video camera 100 according to the first embodiment will be described with reference to FIGS. 7 to 9. FIG. 7 is a flowchart for describing the exposure metering and exposure control operations in the digital video camera 100. FIG. 8 is a diagram for describing center-weighted exposure metering for capturing a 2D image. FIG. 9 is a diagram for describing the center-weighted exposure metering for capturing a 3D image.

Referring to FIG. 7, when the digital video camera 100 is set to a shooting mode by a user (S100), the controller 210 determines whether or not the 3D conversion lens 500 is attached to the digital video camera 100 based on a signal from the detection switch 290 (S110). When the determination is made that the 3D conversion lens 500 is not attached, the controller 210 sets a metering region for capturing a 2D image in the captured image (S115), and carries out the center-weighted exposure metering on the metering region (5120). The metering region and the center-weighted exposure metering will be described below.

When a 2D image is captured, the metering region is set as shown in FIG. 8A. The center-weighed exposure metering is carried out on a metering region 191. The center-weighted exposure metering is a method including dividing an image captured by the CCD image sensor 180 into a plurality of regions and metering brightness of the image with a focus on the center portion. Concretely, the digital video camera 100 divides the metering region 191 of the image captured by the CCD image sensor 180 into thirty regions of 6×5 as shown in FIG. 8A. A weight coefficient 1.0 is set for six regions at the center portion of the divided regions. A weight coefficient 0.5 is set for six regions adjacent to the center portion. Further a weight coefficient 0.3 is set for eighteen regions around these regions. At the time of capturing a 2D image, the controller 210 obtains a weighted average (E) of the brightness of the image captured by the CCD image sensor 180 according to the following equation (1). The weighted average (E) of the brightness of the image is a metering value obtained by the center-weighted exposure metering.

$$E = \frac{\sum ( Yij \times Wij )}{\sum Wij} \qquad ( 1 )$$

In the equation (1), “W” is a weight coefficient of each divided region, and “Y” is brightness of an image of each divided region (for example, an average value of brightness of pixels included in the divided regions). Where, “i” and “j” are subscripts for specifying x and y positions of the divided regions.

When the 3D conversion lens 500 is attached to the digital video camera 100, the light falloff at the center occurs. For this reason, when the 3D conversion lens 500 is attached to the digital video camera 100, the exposure metering operation in consideration of the light falloff at the center should be performed. On the contrary, when a 2D image is captured with the 3D conversion lens 500 not attached to the digital video camera 100, the light amount becomes uniform in the metering region 191 as shown in FIG. 5B. In this case, during the exposure metering operation, the light falloff at the center does not have to be taken into consideration. FIG. 8A illustrates the metering region for capturing a 2D image, which is different from the metering region for capturing a 3D image. The metering region for capturing a 3D image will be described later.

Returning to FIG. 7, after the completion of the center-weighted exposure metering (S120), the controller 210 performs the exposure control using a metering value (E) obtained by the center-weighted exposure metering (S130). Concretely, the controller 210 adjusts an aperture value of the diaphragm 295, a shutter speed of the CCD image sensor 130, and a gain provided to a captured image so that the metering value (E) becomes a predetermined target value. That is, the controller 210 controls the diaphragm actuator 300, the CCD image sensor 180, and the image processor 190.

On the other hand, the determination is made in step S110 that the 3D conversion lens 530 is attached to the digital video camera 100, the controller 210 sets the metering region for capturing a 3D image (S140). Concretely, as shown in FIG. 9A, a metering region 193 is set in a left-eye image 182 of images 182 and 184 captured by the CCD image sensor 180. The metering region 193 is also divided into thirty regions of 6×5, and the weighted average (E) of the brightness of the image is obtained by using the brightness of each divided region.

When the metering region is changed, the controller 210 corrects a light amount of a captured image (S150). Concretely, as shown in FIG. 98, the light amount is corrected in a range in which the light amount on the metering region 193 falls off. That is, the light amount is corrected so that the light amount becomes constant regardless of the positions of the image in the horizontal direction. This is because, if such a correction of the light amount is not made, the center-weighted exposure metering cannot be accurately carried out due to an influence of the light falloff at the center that occurs in the metering region 193. According to the present embodiment, when the 3D conversion lens 500 is attached to the digital video camera 100, the digital video camera 100 corrects the light falloff at the center of the captured image, and carries out the center-weighted exposure metering with the corrected data.

The correction of the light falloff at the center on the captured image is realized by correcting the brightness of the image according to the following equation (2).

Y′ij−Yij·Ci (2)

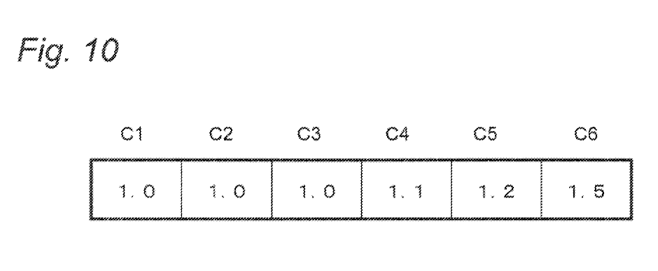

In the equation (2), “Y” is the brightness (luminance) of an image on each divided region. “C” is a correction coefficient for the brightness of the image on each divided region, and “Y′” is the corrected brightness of the image on each divided region. Where, “i” and “j” are subscripts for specifying x and y positions on the divided regions. The correction coefficient C is set based on a property of the light falloff at the center so that the property after the correction becomes fiat as shown in FIG. 93. FIG. 10 illustrates an example of the correction coefficient C. Information about the correction coefficient is stored in the internal memory 280.

After the light amount is corrected (S150), the controller 210 carries out the center-weighted exposure metering using the corrected image data according to the equation (3) (S160). After the center-weighted exposure metering is carried cut, the controller 210 performs the exposure control using the metering value (E) calculated by the center-weighted exposure metering (S170).

$$E = \frac{\sum ( {Y}^{′} ij \times Wij )}{\sum Wij} \qquad ( 3 )$$

As described above, when the 3D conversion lens 500 is attached, the digital video camera 100 according to the present embodiment corrects the light falloff at the center of the captured image, and carries out the center-weighted exposure metering on the corrected data. That is, the metering value is corrected based on the property of the light falloff at the center, and the center-weighted exposure metering is carried out based on the corrected metering value. Such correction of the metering value in view of the light falloff at the center allows the influence of the light falloff caused by the 3D conversion lens 500 to be eliminated, so that the accurate exposure metering can be realized. Therefore, even when the 3D conversion lens 500 providing non-uniform light amount in the metering region is attached, the suitable center-weighted exposure metering can be carried out.

### 1-5. Correspondence to the Invention

The CCD image sensor 190 is one example of an imaging device according to the present invention. The connecting section 640 is one example of a connecting unit according to the present invention. The controller 210 is one example of a metering unit according to the present invention. The configuration including the diaphragm 295, the diaphragm actuator 300, the CCD image sensor 180 and the image processor 190 is one example of an exposure adjusting unit according to the present invention. The controller 210 is one example of a correcting unit according to the present invention. The metering value obtained by the center-weighted exposure metering is one example of the measuring information according to the present invention.

### 2. Other Embodiments

In the foregoing, the first embodiment has been described as an embodiment of the present invention. However, the present invention is not limited to the above embodiment. Therefore, other embodiments of the present invention will be described here.

The optical system and the drive system in the digital camera 100 according to the present embodiment are not limited to those shown in FIG. 1. For example, FIG. 3 illustrates the optical system composed of three groups, but it may be composed of other number of groups. Further, the respective lenses may be composed of one lens or a lens group including a plurality of lenses.

The first embodiment illustrates the CCD image sensor 180 as the imaging unit, but the imaging unit is not limited to this. For example, the imaging unit may be implemented by a CMOS image sensor or an NMOS image sensor.

In the first embodiment, the center-weighted exposure metering is used as an exposure metering system, but the metering system is not limited to this. The metering system may be another metering method, such as division exposure metering or spot exposure metering.

In the first embodiment, as shown in FIG. 9A, the motoring region is provided in a region of a left-eye image, but it may be provided in a region of a right-eye image.

In the first embodiment, in order to eliminate influence of the light falloff at the center to the metering value E, when the 3D conversion lens 500 is attached, the metering value E is obtained using the corrected brightness of the image. It is not limited to this method. In order to eliminate influence of the light falloff at the center to the metering value E, the weight (W) may be corrected and the metering value E may be obtained by using the corrected weight (W′). For example, in a region where the light falloff occurs in the captured image, the weight (W) may be multiplied by a correction coefficient. Specifically, the metering value (E) may be calculated according to the following equations (4a) and (4b). In the equations (4a) and (4b), “C” is a predetermined correction coefficient, which has, as shown in FIG. 10, a value of 1 on a region of the captured image where the light falloff at the center does not occur and has a value larger than 1 on a region where the light falloff at the center occurs. “W′” is a weight multiplied by the correction coefficient (C)

$$\begin{matrix}E = \frac{\sum ( Yij \times {W}^{′} ij )}{\sum Wij} & ( 4 a ) \\ {W}^{′} ij = Wij \times Ci & ( 4 b )\end{matrix}$$

In other words, in the respective embodiments of the present invention, when the 3D conversion lens 500 is attached to the digital video camera 100, the metering value obtained from a captured image is corrected based on the correction coefficient set based on the light falloff at the center, and the exposure control is carried out by using the corrected metering value. Such correction of the metering value in consideration of the light falloff at the center allows the influence of the light falloff caused by the 3D conversion lens 500 to be eliminated, thereby realizing the accurate exposure metering.

### INDUSTRIAL APPLICABILITY

The present invention is useful for imaging apparatuses such as a digital video camera and a digital still camera to which a 3D conversion lens for enabling a stereoscopic image to be shot, by a single lens imaging apparatus can be attached.

What is claimed is:

1. An imaging apparatus comprising:
an imaging device configure to generate image data from a subject image;
a connecting unit configured to connect a 3D conversion lens for enabling a left-eye image and a right-eye image to be simultaneously formed on the imaging device;
a measuring unit configured to obtain brightness of an image formed on the imaging device, and generate measuring information representing the brightness of the image formed on the imaging device based on the obtained brightness of the image;
an exposure adjusting unit configured to control exposure on the imaging device based on the measuring information; and
a light amount correcting unit configured to reduce an influence of light falloff occurring in the image formed on the imaging device to the measuring information, when the 3D conversion lens is connected to the connecting unit.

2. The imaging apparatus according to claim 1, wherein
the light amount correcting unit corrects the brightness of the image obtained according to a property of the light falloff to reduce the influence of light falloff to the measuring information.

3. The imaging apparatus according to claim 1, wherein
a region of the image is divided into a plurality of regions, and a weight is set on each divided region,
the measuring unit weights the brightness of the image on each divided region to obtain the measuring information, and
the light amount correcting unit corrects the weight of each divide region according to the property of the light falloff to reduce the influence of light falloff to the measuring information.

4. The imaging apparatus according to claim 3, wherein a weight for divided region at a center of a left-eye image region or a right-eye image region in the image or adjacent to the center is set to be larger than a weight for the other divided region than the divided region at the center or adjacent to the center.

5. The imaging apparatus according to claim 2, wherein the light amount correcting unit corrects the obtained brightness of the image so as to enhance brightness of image at the center of horizontal direction of the imaging device or brightness of image adjacent to the center.

6. The imaging apparatus according to claim 3, wherein the light amount correcting unit corrects the weight for the divided region so as to enhance brightness of image at the center of horizontal direction of the imaging device or brightness of image adjacent to the center.
